(19) United States
(12) Patent Application Publication
(10) Pub. No.: US 2025/0358160 A1
(43) Pub. Date: Nov. 20, 2025

(54) JOINT SENSING CONTROL METHOD AND RELATED USER EQUIPMENT FOR ORTHOGONAL FREQUENCY DOMAIN MULTIPLEXING COMMUNICATION SYSTEM

(71) Applicant: MEDIATEK INC., Hsin-Chu (TW)

(72) Inventors: Rui Zhang, San Jose, CA (US); Shiauhe Tsai, San Jose, CA (US); Jiaying Ren, San Jose, CA (US); Tzu-Han Chou, San Jose, CA (US)

(73) Assignee: MEDIATEK INC., Hsin-Chu (TW)

(21) Appl. No.: 18/666,793

(22) Filed: May 16, 2024

(51) Int. Cl. H04L 27/26

(52) U.S. Cl. CPC H04L 27/26025; H04L 27/2636

(57) ABSTRACT

A joint sensing control method for an orthogonal frequency domain multiplexing (OFDM) communication system includes receiving, from a sensing terminal, a first message or a first set of initiation message; configuring at least a reference signal according to the first message or the first set of initiation message; transmitting the at least a reference signal to the sensing terminal; and adapting a plurality of settings of the at least a reference signal; wherein the first message includes a capability report and the first set of initiation message includes a capability report and a sensing control request.

### BACKGROUND

The reference signal configuration is vital in conventional sensing performance when the orthogonal frequency domain multiplexing (OFDM) is applied to joint communication and sensing, especially for bi-static sensing.

However, depending on the reference signal patterns and the sensing algorithms, the ambiguity properties in the delay (i.e., distance) and the Doppler frequency (i.e., velocity) domain may be different.

### SUMMARY

In light of this, the present invention provides a joint sensing control method and related user equipment for an orthogonal frequency domain multiplexing (OFDM) communication system to optimally utilize various RS patterns and sensing algorithms to reach efficient use of resources and best achievable performance by a new mechanism, sensing control in the air interface.

An embodiment of the present invention provides a joint sensing control method for an orthogonal frequency domain multiplexing (OFDM) communication system, comprises receiving, from a sensing terminal, a first message or a first set of initiation message; configuring at least a reference signal according to the first message or the first set of initiation message; transmitting the at least a reference signal to the sensing terminal; and adapting a plurality of settings of the at least a reference signal; wherein the first message includes a capability report and the first set of initiation message includes a capability report and a sensing control request.

Another embodiment of the present invention provides a user equipment (UE) of an orthogonal frequency domain multiplexing (OFDM) communication system, comprises a wireless transceiver, configured to perform wireless transmission and reception to and from a service network; and a controller, configured to receive from a sensing terminal, a first message or a first set of initiation message; configure at least a reference signal according to the first message or the first set of initiation message; transmit the at least a reference signal to the sensing terminal; and adapt a plurality of settings of the at least a reference signal; wherein the first message includes a capability report and the first set of initiation message includes a capability report and a sensing control request.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication network according to an embodiment of the present invention.

FIG. 2 is a schematic diagram of a layer-3 sensing control flowchart according to an embodiment of the present invention.

FIG. 3 is a schematic diagram of a layer-2 sensing configuration adaption flowchart according to an embodiment of the present invention.

FIG. 4 is a schematic diagram of a layer-1 indicator sensing control flowchart according to an embodiment of the present invention.

FIG. 5 is a schematic diagram of a comb structure of an RS pattern according to an embodiment of the present invention.

FIG. 6 is a schematic diagram of an example of snapshot for comb-based RS symbols according to an embodiment of the present invention.

FIG. 7A and FIG. 7B are schematic diagrams of side peak effects of MUSIC and periodogram according to an embodiment of the present invention.

FIG. 8 is a schematic diagram of normalized mean squared error versus SNR of MUSIC and periodogram according to an embodiment of the present invention.

FIG. 9 is a schematic diagram of sensing control flowchart according to an embodiment of the present invention.

### DETAILED DESCRIPTION

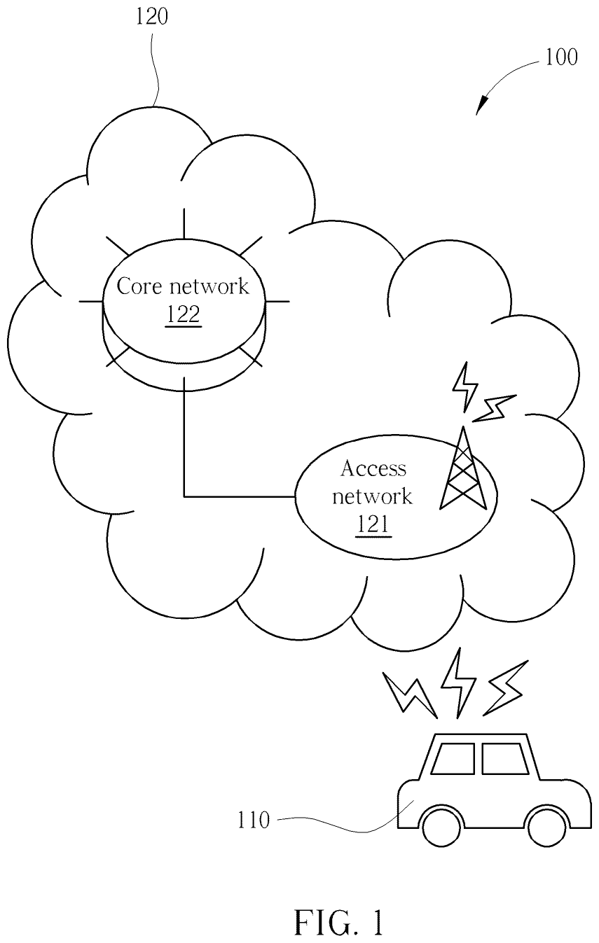

FIG. 1 is a schematic diagram of a wireless communication network 100 according to an embodiment of the present invention.

As shown in FIG. 1, the wireless communication network 100 may include a user equipment (UE) 110 and a service network 120, wherein the UE 110 may be wirelessly connected to the service network 120 for obtaining mobile services and performing cell measurements to the cell(s) of the service network 120.

The UE 110 may be a feature phone, a smartphone, a panel Personal Computer (PC), a laptop computer, a moving vehicle or any wireless communication device supporting the wireless technology (e.g., the 5G NR technology) utilized by the service network 120. In another embodiment, the UE 110 may support more than one wireless technology. For example, the UE may support the 5G NR technology and a legacy 4G technology, such as the LTE/LTE-A/TD-LTE technology.

The service network 120 includes an access network 121 and a core network 122. The access network 121 is responsible for processing radio signals, terminating radio protocols, and connecting the UE 110 with the core network 122. The core network 122 is responsible for performing mobility management, network-side authentication, and interfaces with public/external networks (e.g., the Internet). Each of the access network 121 and the core network 122 may comprise one or more network nodes for carrying out said functions.

In one embodiment, the service network 120 may be a 5G NR network, and the access network 121 may be a Radio Access Network (RAN) and the core network 122 may be a Next Generation Core Network (NG-CN).

A RAN may include one or more cellular stations, such as next generation NodeBs (gNBs), which support high frequency bands (e.g., above 24 GHZ), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

A 5G cellular station may form one or more cells with different Component Carriers (CCs) for providing mobile services to the UE 110. For example, the UE 110 may camp on one or more cells formed by one or more gNBs or TRPs, wherein the cells which the UE 110 is camped on may be referred to as serving cells, including a Primary cell (Pcell) and one or more Secondary cells (Scells).

An NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QOS). Based on the information, the PCF determines policies about mobility and session management to make the AMF and the SMF operate properly. The AUSF stores data for authentication of UEs, while the UDM stores subscription data of UEs.

In another embodiment, the service network 120 may be an LTE/LTE-A/TD-LTE network, and the access network 121 may be an Evolved-Universal Terrestrial Radio Access Network (E-UTRAN) and the core network 122 may be an Evolved Packet Core (EPC).

An E-UTRAN may include at least one cellular station, such as an evolved NodeB (eNB) (e.g., macro eNB, femto eNB, or pico eNB), each of which may form a cell for providing mobile services to the UE 110. For example, the UE 110 may camp on one or more cells formed by one or more eNBs, wherein the cells which the UE 110 is camped on may be referred to as serving cells, including a Pcell and one or more Scells.

An EPC may include a Home Subscriber Server (HSS), Mobility Management Entity (MME), Serving Gateway (S-GW), and Packet Data Network Gateway (PDN-GW or P-GW).

It should be understood that the wireless communication network 100 described in the embodiment of FIG. 1 is for illustrative purposes and is not intended to limit the scope of the application. For example, the wireless communication network 100 may include both a 5G NR network and a legacy network (e.g., an LTE/LTE-A/TD-LTE network, or a WCDMA network), and the UE 110 may be wirelessly connected to both the 5G NR network and the legacy network.

An embodiment of the present invention provides a sensing control method of adapting sensing configuration over the air interface, which includes adapting RS pattern and its parameter set based on measurement receiver reporting through radio resource configuration (RRC) messages, medium access control (MAC) control element (CE) enable/disable, physical layer control indication, or a combination thereof. In addition, the sensing control method may be applied to either new 6G joint communication sensing, or improvement over existing 5G NR, RS patterns.

Sensing control method includes air interface RS pattern adaptation and the processing method optimization. The criteria for optimization include system radio resource allocation, processing power/resource constraints, and targeted application requirements.

The air interface adaptation for joint sensing control includes the following aspects:

Reference signal transmitter may adjust RS settings by layer-3 (L3) radio resource configuration (RRC) messages, or layer-2 (L2) medium access control (MAC) control elements (CES), or layer-1 control indictors, e.g., DL control indicator (DCI) or UL control indicator (UCI), or a cross-layer combination thereof.

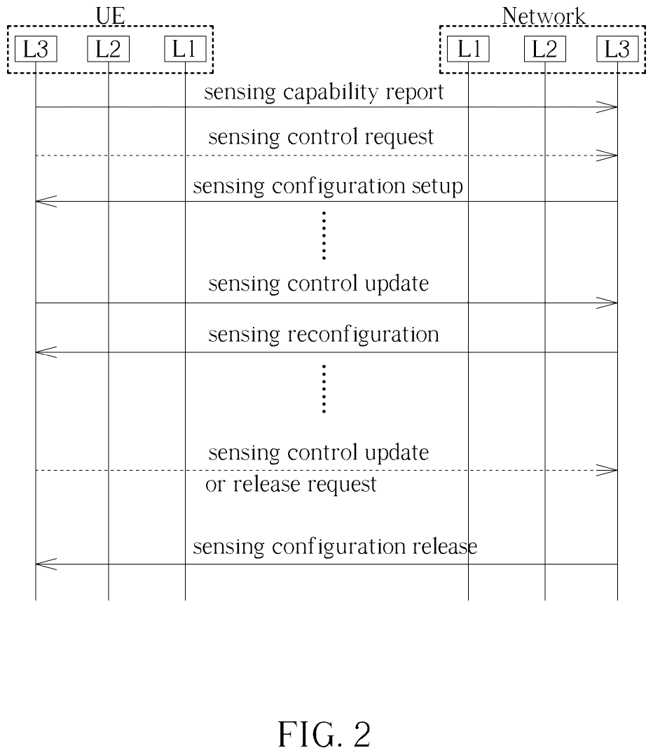

a. RRC messages may be a general-purpose RRC setup or reconfiguration message that contains the RS settings there within. Another embodiment may be a dedicated sensing configuration setup or a dedicated sensing reconfiguration message for RS settings.
i. RS settings provided by RRC messages may be directly applied by the receiver for sensing measurements or stored at the receiver for lower-layer selection.
ii. One embodiment of RRC-message-based sensing control procedure is illustrated in FIG. 2, where the network is the RS transmitter and the UE is the RS receiver.

b. An RRC message for sensing control update may be a new message, or a new field added to an existing L3 message such as UE assisted information (UAI) message.

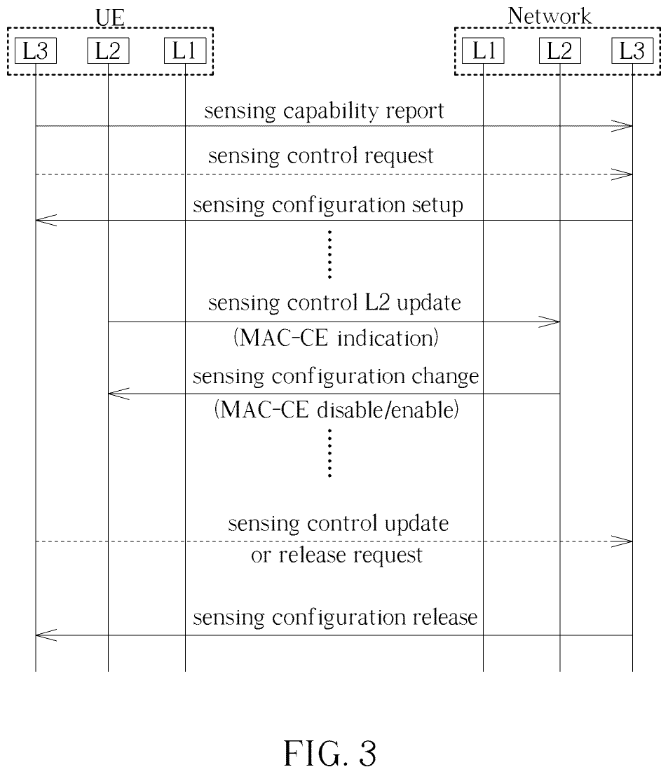

c. MAC-CE may, based on RS settings given by RRC configuration, select and activate one or multiple RS settings to be measured at the receiver. To achieve the RS pattern adaptation, another MAC-CE may deactivate and reselect other RS setting(s) for the receiver to measure.
i. RS settings activated by MAC-CE may be directly applied by the receiver for sensing measurements or stored at the receiver for physical layer selection.
ii. One embodiment of MAC-CE-based sensing control procedure is illustrated in FIG. 3, where the network is the RS transmitter and the UE is the RS receiver.

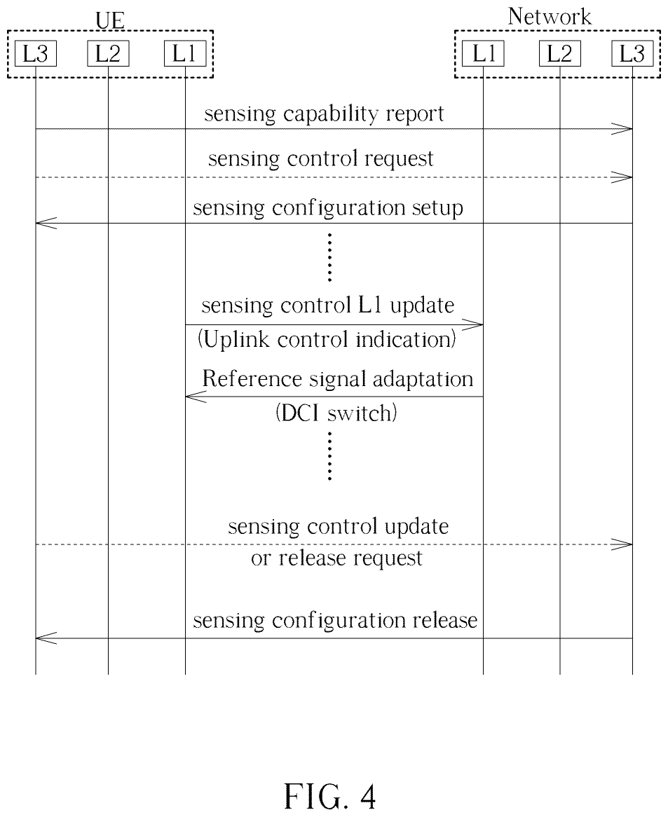

d. L1 control indicator may point to, based on RS settings given by RRC configuration, or by MAC-CE activation, RS setting(s) for the receiver to perform sensing.
i. The L1 control indicator may be a DCI if the RS is transmitted by the network, a UCI if transmitted by the UE.
ii. The L1 control indicator may add, delete, or switch between, RS settings for the receiver to measure.
iii. One embodiment of L1-DCI-based procedure is illustrated in FIG. 4.

Another method of negotiating/adjusting RS settings and reporting measurements is an over-the-top (OTT) approach, i.e., above the access stratum (AS), by adding new information fields for sensing to an existing message, or new messages, in upper-layer protocols. Examples of said upper-layer protocols may include, but not limited to, LTE positioning protocol (LPP), NR positioning protocol A (NRPPa), or secure user-plane location (SUPL).

From the reference signal receiver side, sensing control request and/or update may be sent via RRC message(s), MAC-CE(s), L1 control indicator(s), or a cross-layer combination thereof, to communicate preferred or supported RS settings.

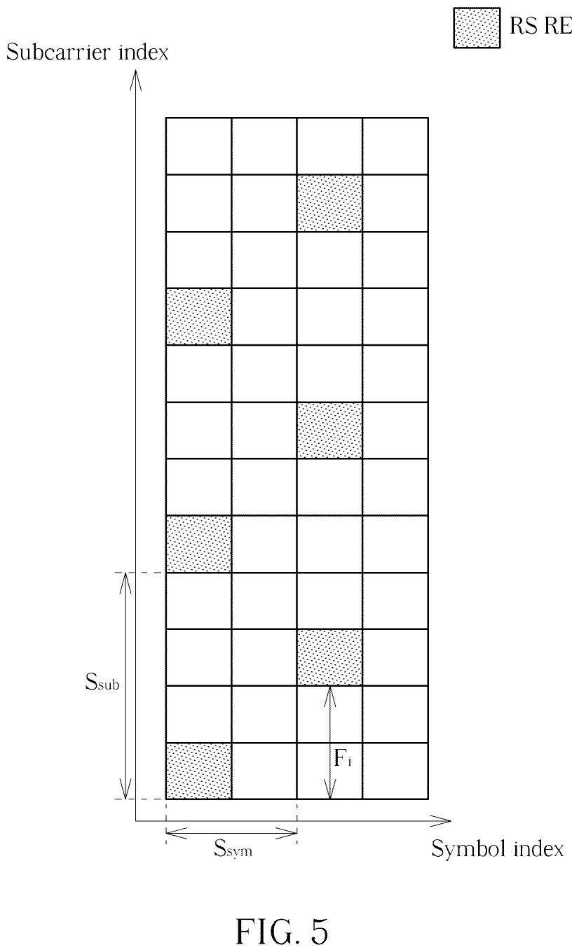

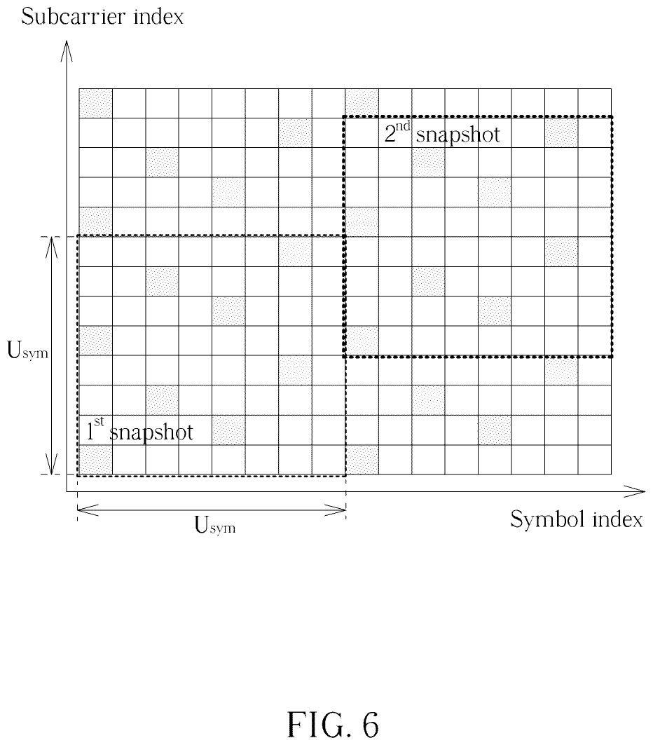

As shown in FIG. 5 and FIG. 6, the RS settings include:
a. Number of REs to the next non-zero-power RE in a frequency comb: S_{sub};
b. Number of symbols to the next RS symbol in time: S_{sym};
c. Number of RS symbol in one staggering pattern: U_{F}, or total number of OFDM symbol in a staggering pattern: U_{sym}=S_{sym}·U_{F};
d. Number of combs in an RS symbol: i_{sub}, or total number of frequency REs in an RS symbol: U_{sub}=i_{sub}·S_{sub};
e. Staggering frequency offset sequence of the comb:

$${\{ {F}_{i} \}}_{i = 1}^{{U}_{F}} ;$$

f. Subcarrier spacing (SCS);
g. Indicator for multiplexing of data or none.

On the reference signal receiver side, sensing control adaptation criteria may include characteristics of configured RS pattern, required algorithm resolution, and/or computational complexity constraint. Several embodiments of RS receiver side adaptation are given below.

a. Equal-Strength Side Peak for Larger Native Unambiguous Region for Standard Resolution:

Based on the delay-Doppler ambiguity function (AF) of configured RS pattern, and when the staggering offset sequence produces equal-strength AF side peaks, under computational complexity limitation, the receiver selects standard-resolution algorithms without CLEAN, e.g., RS is configured to a staggering scheme A, wherein the staggering offset is relatively prime to comb size.

b. Unequal-Strength Side Peak for Standard Resolution with CLEAN:

When the staggering offset sequence of configured RS pattern resulting in unequal-strength AF side peaks (e.g., a staggering scheme B, where staggering offset sequence satisfies the anti-condition), the receiver selects standard-resolution algorithms with CLEAN.

c. Super-Resolution with Minimal Number of RS Symbols for Main-Peak Resolution:

When the receiver's computing resource is sufficient, and the configured RS pattern frequency staggering offset sequence meets the anti-condition, the receiver selects super-resolution algorithms that may identify AF main peaks of (delay, Doppler) with a minimal RS pattern duration (e.g., 3-symbol for IAA single snapshot, or 3-symbol with spectral smoothing for MUSIC). Such an RS pattern with minimal number of OFDM symbols and staggering offset sequence satisfying the anti-condition is referred to as Canonical-form RS hereafter. The receiver may indicate the said minimal RS duration to the transmitter via sensing control request/update for overhead reduction.

d. Adapting RS Pattern Parameters for Different Resolution:

Based on requirements, the resolution in delay and Doppler may be increased by adjusting U_{sub}, the frequency domain span, and U_{sym}, the time domain span, of the RS pattern, respectively. If super-resolution MUSIC algorithm is supported by the receiver, best staggering scheme with spectral smoothing may be negotiated to satisfy the application requirement.

e. Power-Resource-Based RS-Pattern Adaptation:

The reference signal receiver may send a sensing control request/update based on its power and/or resource. For example, when the receiver needs to reduce its power consumption on successive cancellation algorithms such as CLEAN, or cut down its processing time over computational resources, the receiver may send sensing control request/update to indicate its preference of the staggering scheme A (i.e., equal-strength AF side peaks) and optionally with varying staggering offsets (i.e., distinct side peak locations) such that inconsistent (i.e., delay, Doppler) peaks may be eliminated by logical deduction over snapshots measured under different staggering offsets.

f. Extended Guard Interval Capability for More Sensing ISI-Free Bands:

A receiver may adopt post-FFT algorithms processing RS measurement in the frequency domain (2D-FFT/MUSIC/IAA/compressed-sensing-type), with inter-symbol-interference (ISI) guard intervals limited to the OFDM symbol fraction corresponding non-zero-RS-comb distance. When the receiver is capable of processing OFDM RS measurement over multiple frequency bands with different cyclic prefix lengths, it may extend ISI guard intervals for frequency-domain-based algorithms up to one-minus-comb-density RS symbol lengths to overcome the limitation of CP length. By signaling the capability of the receiver, frequency bands with much smaller CP length may still be added to the source of reference signals. For example, a Frequency Range 1 (FR1) 15 kHz-SCS has a CP of 4.69 us with a symbol duration 71.354 μs, and an FR2 120 kHz SCS has a CP of 0.59 us with a symbol duration 8.919μ. To align maximum ISI-free delay measurement in FR2 beyond 0.59 μs, the receiver may keep the last portion of (1/comb-size)-th OFDM symbol samples for sensing. This approach of extending guard intervals beyond larger-SCS OFDM symbol's CP enables complementary sensing availability across wide frequency ranges, giving more flexibility in RS resource allocation (spreading out overheads to avoid overloading particular bands), the same ISI-free maximum delay spread tolerance and thus offering combined processing for synthetic sensing enhancements across frequency bands.

Another choice for the RS receiver processing is reverting to time-domain processing (i.e., delay-and-sum). The time-domain approach has no hard CP limitation. Its delay extreme is equivalent to OFDM symbol length and the range of Doppler spread is not susceptible to SCS limitation.

g. SNR-Based Algorithm Switch and RS Pattern Requirement Feedback:

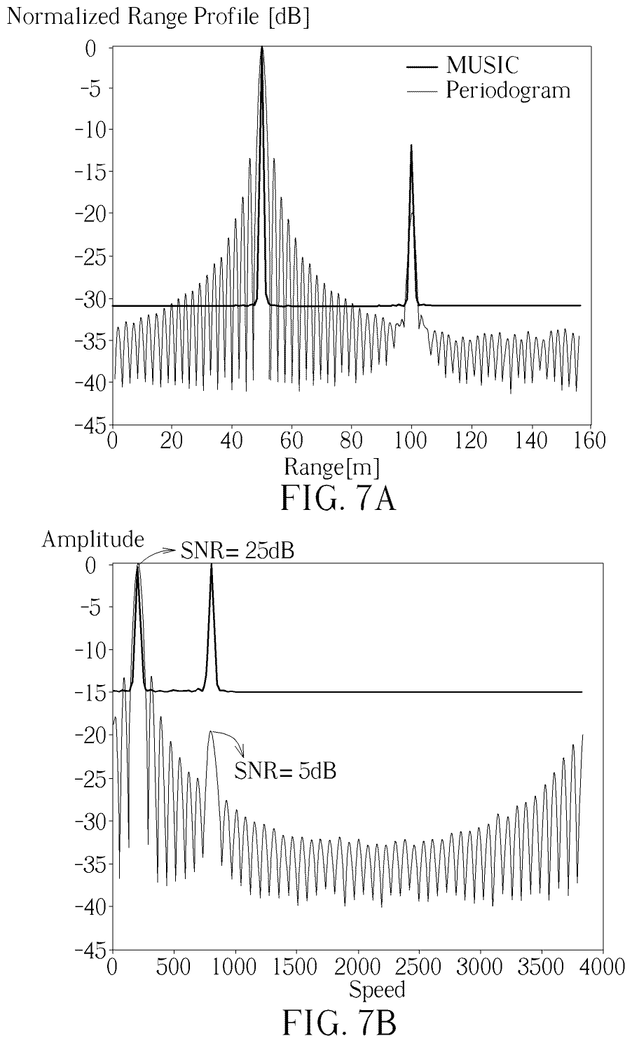

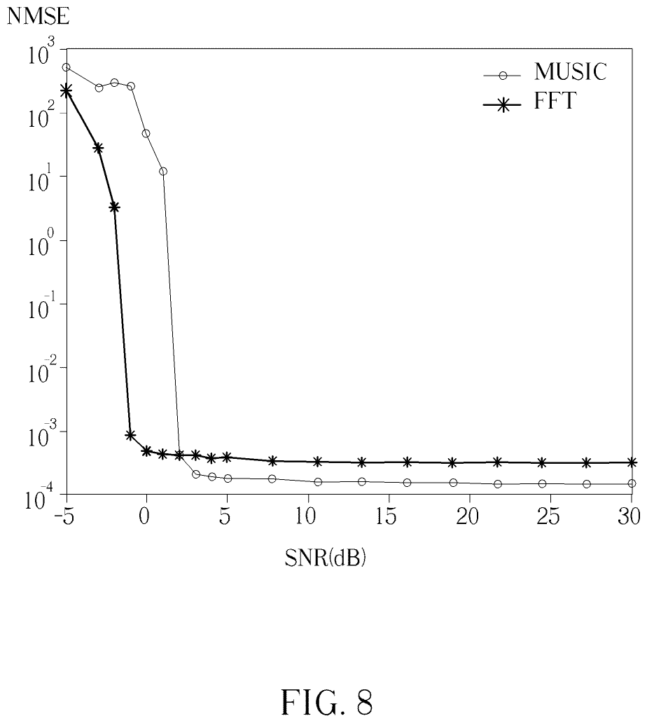

The receiver may switch its processing algorithm (e.g., between periodogram and MUSIC) based on received RS signal-to-noise ratio (SNR) and thereby report RS pattern preference through sensing control request/update. For the example between periodogram and MUSIC, FIG. 7A and FIG. 7B show the better weaker target detection capability of MUSIC under good SNR, and FIG. 8 shows how the mean squared error (MSE) of MUSIC and that of periodogram cross over each other as SNR decreases. When the received RS SNR drops below a value that MUSIC may longer sustain the desired MSE, the receiver may signal the RS pattern required by periodogram. Vice versa the receiver may signal the minimal RS pattern duration for MUSIC when the SNR rises above the value corresponding to the desired MSE.

h. Switching from or Fallback to Delay-Only:

The receiver may switch between joint delay/Doppler to delay-only RS processing, either based on sensing requirements from upper-layer applications, or the reference signal resources that may be allocated for sensing. For the requirement-based case, if the overarching sensing application only requires delay information, the receiver may request RS resources that are sufficient for delay-only estimation. When the application demands both location and speed of the target, the receiver then updates its requested RS resources to be configured in a way that estimation of both delay and Doppler may be satisfied. For the other case, when allocated RS resources are not sufficient for both delay and Doppler estimation, the receiver may opt to fall back to provide distance estimates only.

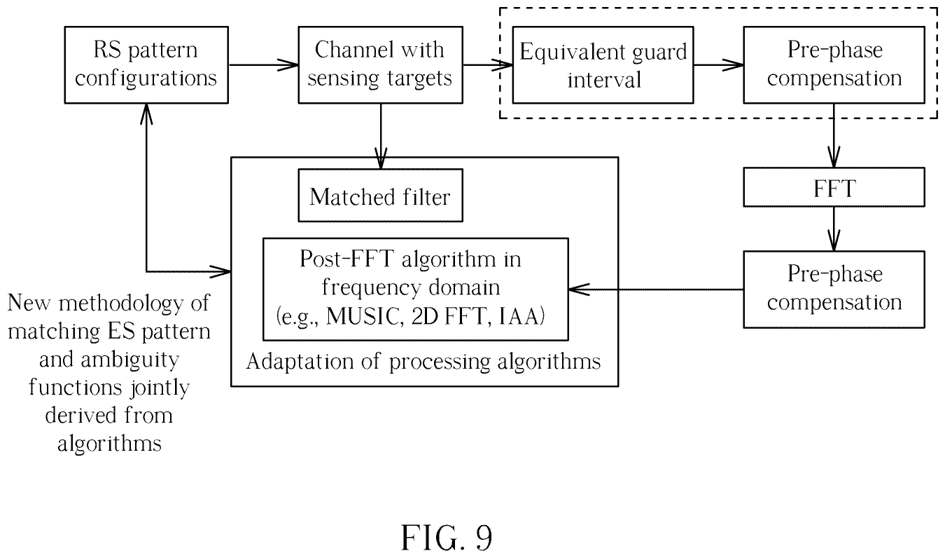

To summarize, logical flow of sensing control and inter-relations between functional blocks of the methodology is given in FIG. 9. Various aspects of standard- and super-resolution algorithms are given in Table 1.

TABLE 1

| Standard-resolution algorithms | Super-resolution algorithms |
|---|---|
| 1. Delay-and-sum (time-domain | 1. Construction of steering |
| MF-based); | matrix (A-matrix) for MUSIC and |
| 2. 2-D periodogram-based | IAA; |
| algorithms; | 2. Canonical-form RS (partial |
| 3. Staggering-specific 2D | staggering cycle sufficiency |
| max-unambiguity | for peak elimination). |
| characterization; | |
| 4. Side-peak elimination | |
| criteria over full staggering | |
| cycle; | |
| 5. Anti-conditions for | |
| unequal-strength-side-peak | |
| ambiguity function (enabling | |
| CLEAN, i.e., SIC). | |

1. Design for both CP-OFDM and DFT-s-OFDMs;
2. Novel equivalent guard interval for large-SCS frequency-domain-operated sensing algorithm's channel delay range extension.

Notably, those skilled in the art may properly design the joint sensing control method and the UE according to different system requirements, which are not limited thereto.

In summary, the present invention provides a joint communication and sensing method and related user equipment (UE) for an orthogonal frequency domain multiplexing (OFDM) communication system to utilize various RS patterns and sensing algorithms to reach efficient use of resources and best achievable performance by a new mechanism, sensing control in the air interface.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A joint sensing control method for an orthogonal frequency domain multiplexing (OFDM) communication system, comprising:
receiving, from a sensing terminal, a first message or a first set of initiation message;
configuring at least a reference signal according to the first message or the first set of initiation message;
transmitting the at least a reference signal to the sensing terminal; and
adapting a plurality of settings of the at least a reference signal;
wherein the first message includes a capability report and the first set of initiation message includes a capability report and a sensing control request.

2. The joint sensing control method of claim 1, further comprising:
indicating, by the sensing terminal, at least a reference signal setting preference; and
responding with at least a modification to settings of the at least a reference signal to the sensing terminal.

3. The joint sensing control method of claim 2, further comprising:
indicating, by the sensing terminal, a sensing release request; and
responding with a sensing configuration release message to the sensing terminal.

4. The joint sensing control method of claim 1, wherein the plurality of settings of the at least a reference signal include employing a plurality of radio resource configuration messages, medium access control elements, physical-layer control indicator, or a combination of the plurality of radio resource configuration messages, medium access control elements and a physical-layer control indicator.

5. The joint sensing control method of claim 1, wherein the at least a reference signal is utilized to configure a representation of a reference signal (RS) pattern, a sequence of reference signal patterns, or both.

6. The joint sensing control method of claim 5, wherein the RS pattern is in the form of orthogonal frequency domain multiplexing (OFDM) and the RS pattern includes a comb density, a symbol density, a staggering offset sequence, a subcarrier spacing, existence or lack of data multiplexing, a total number of reference signal symbol, a total number of reference signal resource element.

7. The joint sensing control method of claim 6, wherein the OFDM form is cyclic-prefixed OFDM (CP-OFDM) or Discrete-Fourier-Transform-spread OFDM (DFT-S-OFDM).

8. The joint sensing control method of claim 5, wherein the sequence of reference signal patterns includes at least a subset of a sequence identifier, a plurality of component RS pattern identifiers, a time duration/offset of the component RS pattern, a frequency range of component RS pattern.

9. The joint sensing control method of claim 6, wherein the step of adapting a plurality of settings of the at least a reference signal comprises:
determining a delay-and-sum in time-domain or a frequency-domain processing according to the RS pattern and corresponding a delay-Doppler estimation;
determining an interference cancellation under the RS pattern satisfying an anti-condition when a staggering offset sequence of the RS pattern has an unequal-strength ambiguity function side peak;
determining a set of super-resolution algorithms with a spectral smoothing or a single snapshot, based on an availability of time and frequency offset of a plurality of spectral smoothing snapshots; or
determining fallback from a post-FFT frequency domain processing to a time-domain processing.

10. The joint sensing control method of claim 8, wherein the step of adapting a plurality of settings of the at least a reference signal comprises:
determining a delay-and-sum in time-domain or a frequency-domain processing according to the RS pattern and corresponding a delay-Doppler estimation;
determining an interference cancellation under the RS pattern satisfying an anti-condition when a staggering offset sequence of the RS pattern has an unequal-strength ambiguity function side peak;
determining a set of super-resolution algorithms with a spectral smoothing or a single snapshot, based on an availability of time and frequency offset of a plurality of spectral smoothing snapshots; and
determining fallback from a post-FFT frequency domain processing to a time-domain processing.

11. A user equipment (UE) of an orthogonal frequency domain multiplexing (OFDM) communication system, comprising:
a wireless transceiver, configured to perform wireless transmission and reception to and from a service network; and
a controller, configured to receive from a sensing terminal, a first message or a first set of initiation message; configure at least a reference signal according to the first message or the first set of initiation message; transmit the at least a reference signal to the sensing terminal; and adapt a plurality of settings of the at least a reference signal;
wherein the first message includes a capability report and the first set of initiation message includes a capability report and a sensing control request.

12. The UE of an OFDM communication system of claim 11, wherein the controller is configured to indicate at least a reference signal setting preference; and to respond with at least a modification to settings of the at least a reference signal to the sensing terminal.

13. The UE of an OFDM communication system of claim 12, wherein the controller is configured to indicate a sensing release request; and to respond with a sensing configuration release message to the sensing terminal.

14. The UE of an OFDM communication system of claim 11, wherein the plurality of settings of the at least a reference signal include employing a plurality of radio resource configuration messages, medium access control elements, physical-layer control indicator, or a combination of the plurality of radio resource configuration messages, medium access control elements and a physical-layer control indicator.

15. The UE of an OFDM communication system of claim 11, wherein the at least a reference signal is s utilized to configure a representation of a reference signal (RS) pattern, a sequence of reference signal patterns, or both.

16. The UE of an OFDM communication system of claim 15, wherein the RS pattern is in the form of orthogonal frequency domain multiplexing (OFDM) and the RS pattern includes a comb density, a symbol density, a staggering offset sequence, a subcarrier spacing, existence or lack of data multiplexing, a total number of reference signal symbol, and a total number of reference signal resource element.

17. The UE of an OFDM communication system of claim 16, wherein the OFDM form is cyclic-prefixed OFDM (CP-OFDM) or Discrete-Fourier-Transform-spread OFDM (DFT-S-OFDM).

18. The UE of an OFDM communication system of claim 15, wherein the sequence of reference signal patterns includes at least a subset of a sequence identifier, a plurality of component RS pattern identifiers, a time duration/offset of the component RS pattern, a frequency range of component RS pattern.

19. The UE of an OFDM communication system of claim 16, wherein the controller is configured to determine a delay-and-sum in time-domain or a frequency-domain processing according to the RS pattern and corresponding a delay-Doppler estimation; determine an interference cancellation under the RS pattern satisfying an anti-condition when a staggering offset sequence of the RS pattern has an unequal-strength ambiguity function side peak; determine a set of super-resolution algorithms with a spectral smoothing or a single snapshot, based on an availability of time and frequency offset of a plurality of spectral smoothing snapshots; or determine fallback from a post-FFT frequency domain processing to a time-domain processing.

20. The UE of an OFDM communication system of claim 18, wherein the controller is configured to determine a delay-and-sum in time-domain or a frequency-domain processing according to the RS pattern and corresponding a delay-Doppler estimation; determine an interference cancellation under the RS pattern satisfying an anti-condition when a staggering offset sequence of the RS pattern has an unequal-strength ambiguity function side peak; determine a set of super-resolution algorithms with a spectral smoothing or a single snapshot, based on an availability of time and frequency offset of a plurality of spectral smoothing snapshots; or determine fallback from a post-FFT frequency domain processing to a time-domain processing.
